(19) United States
(12) Patent Application Publication
(10) Pub. No.: US 2026/0088617 A1
(43) Pub. Date: Mar. 26, 2026

(54) AI-NATIVE ENERGY ORCHESTRATION ROUTER FOR MANAGING DISTRIBUTED ENERGY ASSETS OF A BUILDING

(71) Applicant: EnnoFlow Technologies, Inc., Round Rock, TX (US)

(72) Inventor: Ignacio Juarez, Round Rock, TX (US)

(21) Appl. No.: 19/334,814

(22) Filed: Sep. 20, 2025

Related U.S. Application Data
(60) Provisional application No. 63/697,372, filed on Sep. 20, 2024.
(60) Provisional application No. 63/697,377, filed on Sep. 20, 2024.

(51) Int. Cl. H02J 3/00; G01D 4/00; G06Q 50/06; H02J 13/00

(52) U.S. Cl. CPC H02J 3/003; G01D 4/004; G06Q 50/06; H02J 13/16

(57) ABSTRACT

The present disclosure provides an energy orchestration router arranged to be installed between a utility energy meter and a main breaker panel of a building. The router includes a communication interface arranged to communicatively couple the router to the utility energy meter, the main breaker panel, and one or more energy assets at the building. The router further includes a power stage arranged to orchestrate bidirectional energy conversion and distribution for the energy assets and at least one processor arranged to perform operations including receiving data from the utility energy meter, the main breaker panel, and the energy assets, generating orchestration policies for allocating energy flows between the energy assets, and executing the orchestration policies in real-time, causing the power stage to control electron flow between the utility energy meter and the energy assets to dynamically optimize operation based on the orchestration policies.

### CROSS-REFERENCE TO RELATED APPLICATIONS

This application claims priority under 35 U.S.C. § 119(e) to U.S. Provisional Application No. 63/697,372 filed Sep. 20, 2024, and U.S. Provisional Application No. 63/697,377 filed Sep. 20, 2024, the entire contents of which are hereby expressly incorporated by reference herein.

### FIELD

The present disclosure relates to energy management systems, and more particularly to an artificial intelligence (AI)-native energy orchestration router configured for installation behind utility meters and ahead main breaker panels in buildings.

### BACKGROUND

The field of distributed energy management has experienced substantial growth as renewable energy technologies, energy storage systems, and electric vehicles become increasingly prevalent in residential, commercial, and industrial settings. Modern power grids, originally designed for centralized generation and unidirectional power flow, face mounting pressure to accommodate bidirectional energy flows, variable renewable generation, and dynamic load patterns while maintaining stability and reliability.

Traditional energy management approaches have largely focused on centralized control systems that aggregate distributed energy resources at the utility scale or simple monitoring solutions that provide limited local control capabilities. Smart panels and modular inverters offer basic load monitoring and control functions but lack sophisticated orchestration capabilities for coordinating multiple energy assets. Centralized platforms can aggregate resources across wide geographic areas but typically rely on cloud connectivity and may not provide the real-time responsiveness needed for optimal grid-edge operations.

The proliferation of distributed energy resources, including rooftop solar installations, residential and commercial battery storage systems, and electric vehicle charging infrastructure, has created new opportunities for enhanced energy efficiency and grid support services. However, coordinating these diverse assets to provide reliable, dispatchable capacity while maintaining local energy optimization presents technical challenges. Existing demand management systems often focus on single asset types or provide energy-only control without considering the broader ecosystem of interconnected resources.

Simultaneously, the computing industry has witnessed the emergence of distributed computing architectures that can leverage idle or underutilized processing resources across networks of devices. Edge computing and distributed processing frameworks have demonstrated the potential to monetize unused computational capacity while providing flexible workload allocation. However, these computing platforms typically operate independently of physical energy infrastructure and do not account for the energy consumption patterns or grid interaction capabilities of their host systems.

### SUMMARY

In one aspect of the present disclosure, an energy orchestration router arranged to be installed between a utility energy meter and a main breaker panel of a building is provided. The router includes a communication interface arranged to communicatively couple the router to the utility energy meter, the main breaker panel, and one or more energy assets provided at the building. The router includes a power stage arranged to orchestrate bidirectional energy conversion and distribution for the one or more energy assets. The router includes at least one processor arranged to perform operations including receiving data from the utility energy meter, the main breaker panel, and the one or more energy assets, generating orchestration policies for allocating energy flows between the one or more energy assets, and executing the orchestration policies, in real-time, causing the power stage to variously control the flow of electrons between the utility energy meter and the one or more energy assets to dynamically optimize operation of the one or more energy assets based on the orchestration policies.

In some aspects, the router may include one or more of the following features.

In some aspects, the one or more energy assets may include any of distributed energy resources (DERs), energy storage systems (ESSs), electric vehicles (EVs), flexible and non-flexible loads on the building, and one or more compute resources.

In some aspects, the orchestration policies may leverage artificial intelligence (AI) models to determine load behavior of the one or more energy assets over time to aid in dynamically optimizing operation of the one or more energy assets.

In some aspects, the orchestration policies, when executed by the at least one processor, may cause the router to allocate computing power from the one or more compute resources into edge compute meshes, while ensuring priority for energy orchestration, thereby creating workload flexibility and enabling monetization of unused processing resources.

In some aspects, the power stage may include at least one inverter/rectifier module and bidirectional DC/DC converters arranged to execute multi-port, bidirectional energy conversion and distribution in accordance with the orchestration policies.

In some aspects, the power stage may be a low-voltage solid-state transformer (LV-SST) arranged to execute multi-port, bidirectional energy conversion and distribution in accordance with the orchestration policies.

In some aspects, the communication interface may include wired and wireless protocols for secure bidirectional data exchange with the one or more energy assets, grid systems, and external APIs.

In some aspects, the external APIs may be arranged to provide the processor with at least one of energy pricing data, compute pricing data, weather forecast data, and carbon intensity level data.

In some aspects, the dynamic optimization may include any one of shifting or curtailing the flexible loads, managing charging and discharging cycles of the ESSs and EVs, and prioritizing any generation sources to provide demand flexibility.

In some aspects, the router may be arranged to interconnect securely with multiple other routers to aggregate flexibility and operate as a coordinated fleet providing dispatchable capacity to utilities or market operators, thereby forming a dispatchable virtual power plant (VPP).

According to another aspect of the present disclosure, a computer-implemented method for autonomous orchestration of distributed energy and compute resources is provided. The method includes collecting, via an energy orchestration router installed between a utility energy meter and a main breaker panel of a building, data from the utility energy meter, the main breaker panel, and one or more energy assets communicatively coupled to the router. The method includes generating, by an artificial intelligence (AI) orchestration model, orchestration policies for allocating energy flows between the one or more energy assets. The method includes executing the orchestration policies, in real-time, causing a power stage of the router to variously control the flow of electrons between the utility energy meter and the one or more energy assets to dynamically optimize operation of the one or more energy assets based on the orchestration policies.

In some aspects, the method may include one or more of the following features.

In some aspects, the one or more energy assets may include any of distributed energy resources (DERs), energy storage systems (ESSs), electric vehicles (EVs), flexible and non-flexible loads on the building, and one or more compute resources.

In some aspects, the data received from the one or more energy assets may include behavior data characterizing how the one or more energy assets are used over time, wherein the method may further include training the AI orchestration model using the behavior data to optimize the orchestration policies.

In some aspects, the executing of the orchestration policies may further cause the power stage of the router to allocate computing power from the one or more compute resources into edge compute meshes based on profitability thresholds and energy availability, wherein the one or more compute resources may be idle or underutilized.

In some aspects, the collecting may further include collecting, via the energy orchestration router, at least one of energy pricing data, compute pricing data, weather forecast data, carbon intensity level data, local router sensor data, and energy asset data from external APIs communicatively coupled to the router, and wherein the generated orchestration policies may further include predictive forecasts for at least one of energy consumption, renewable generation potential, energy pricing, and compute workload profitability based on the collected data.

In some aspects, executing the orchestration policies may cause the router to control shifting or curtailing of the flexible loads, charging and discharging cycles of the ESSs and EVs, and prioritizing renewable generation sources to provide demand flexibility.

In some aspects, the method may further include sharing, via a distributed policy sharing network communicatively coupled to the router, the orchestration policies with a plurality of other energy orchestration routers installed at a plurality of other buildings, generating, by the distributed policy sharing network, a federated learning dataset, and training the AI orchestration model using the federated learning dataset.

In some aspects, executing the orchestration policies may cause the router to autonomously negotiate, with the plurality of other energy orchestration routers installed at the plurality of other buildings, regarding energy pricing and generating trade bids, and the method may further include executing, peer-to-peer energy exchanges with one or more of the plurality of other energy orchestration routers, causing the power stage of the router to variously control the flow of electrons between the utility energy meter and the one or more other energy orchestration routers.

In some aspects, executing the orchestration policies may cause the router to provide dispatchable energy capacity to utilities or market operators, thereby forming a dispatchable virtual power plant (VPP).

### BRIEF DESCRIPTION OF THE DRAWINGS

FIG. 1A illustrates an exemplary energy ecosystem located at the edge of the grid and that includes an energy orchestration router according to the systems and methods described herein;

FIG. 1B is a diagram illustrating one example of an energy orchestration router, according to the systems and methods described herein, tied into an edge energy ecosystem;

FIG. 1C is a diagram illustrating an alternative embodiment of an energy orchestration router, according to the systems and methods described herein, tied into an edge energy ecosystem;

FIG. 1D is a diagram illustrating an exemplary internal architecture of a conventional power stage within the energy orchestration router of FIG. 1B;

FIG. 1E is a diagram illustrating the internal architecture of a low-voltage solid-state transformer within the energy orchestration router of FIG. 1C;

FIG. 2 is a diagram illustrating an exemplary AI orchestration model and data flow architecture according to the systems and methods described herein;

FIG. 3 is a diagram illustrating another exemplary AI orchestration model for distributed energy and compute resources;

FIG. 4A is a diagram illustrating an exemplary multi-source data ingestion and predictive modeling process according to the systems and methods described herein;

FIG. 4B is a diagram illustrating an exemplary internal workflow of a predictive modeling engine according to the systems and methods described herein;

FIG. 5 is a diagram illustrating an exemplary decision optimization and compute arbitrage logic according to the systems and methods described herein;

FIG. 6 is a diagram illustrating an exemplary self-distillation learning engine and distributed policy sharing model according to the systems and methods described herein; and

FIG. 7 is a diagram illustrating an exemplary distributed policy sharing architecture for autonomous orchestration of energy assets and compute workloads according to the systems and methods described herein.

### DETAILED DESCRIPTION

The rapid proliferation of distributed energy resources (DERs), including residential and commercial solar arrays, stationary batteries, and electric vehicles (EVs), has created both opportunities and challenges for modern power systems. While utilities, grid operators, and end-users increasingly require mechanisms to integrate these assets into the grid in ways that enhance stability, improve efficiency, and support decarbonization, existing approaches have largely focused on either centralized aggregation or localized load control, proving insufficient to enable reliable dispatchable capacity at scale.

Current market offerings illustrate these limitations across multiple categories. Smart panels and modular inverters provide basic monitoring and control of household loads and generation but lack the ability to aggregate into dispatchable resources or execute predictive orchestration. Traditional centralized platforms focus on large-scale aggregation but remain heavily cloud-dependent and cannot provide autonomous, real-time flexibility at the grid edge. Traditional demand management systems for behind-the-meter applications are constrained to energy-only control and cannot orchestrate heterogeneous DERs, flexible loads, and EVs into firm, dispatchable virtual power plants. Similarly, emerging distributed grid controllers focus on routing signals but do not incorporate embedded AI decision-making, workload arbitration, or low-latency local control.

In parallel, current decentralized compute platforms have demonstrated methods for distributing and monetizing workloads across distributed nodes. However, these systems operate independently of physical energy infrastructure and cannot influence demand flexibility or participate in transactive energy markets. As a result, they fail to integrate with or leverage the growing ecosystem of DERs, storage, and flexible loads. Existing solutions for energy and compute orchestration are typically siloed, focusing on either energy management or compute allocation, and are often limited to passive monitoring, visualization, or manual control. These systems fail to dynamically coordinate energy flows and compute workloads in real time, and optimize distributed resources under conditions of fluctuating energy pricing, renewable generation, compute demand, and carbon intensity. These systems also fail to enable autonomous, closed-loop execution of orchestration policies across heterogeneous devices and compute marketplaces, and learn continuously from executed actions without exposing sensitive raw telemetry data. Additionally, existing approaches lack compatibility with evolving regulatory frameworks such as demand response programs or balancing market requirements, limiting their ability to participate in emerging flexibility markets.

The present disclosure addresses these shortcomings by introducing an AI-native energy orchestration router that integrates power electronics, embedded compute, and policy-driven and predictive orchestration, thereby creating a new class of infrastructure that bridges energy and data at the grid edge. The disclosed system introduces an AI-driven autonomous orchestration engine capable of real-time, predictive, and adaptive control over both distributed energy assets and compute workloads. It integrates multi-source data ingestion, predictive modeling, decision optimization, and self-distillation learning into a unified orchestration platform that directly interfaces with physical DERs, grid import/export nodes, power stages/solid-state transformers, automatic transfer switches, and distributed compute marketplaces to execute policies without human intervention.

The AI-native energy orchestration router is configured for installation behind the utility meter and ahead of the main breaker panel, integrating advanced power electronics with embedded processing units to enable simultaneous orchestration of DERs, energy storage systems, EVs, flexible and non-flexible loads, and compute resources through AI-driven orchestration policies. This technology-agnostic, plug-and-play edge platform transforms existing infrastructure by connecting physical assets and leveraging AI to create a unified control framework that enables buildings to operate as nodes within dispatchable virtual power plants (VPPs) and participate in peer-to-peer energy trading. Such a unified control framework optimizes operation of energy assets of a building for energy efficiency and energy/compute monetization, or any combination thereof, defined by user load behavior and/or user defined parameters. In some aspects, the user defined parameters can include, for example, monetization priorities (e.g., revenue maximization vs. local consumption), sustainability preferences (e.g., renewable energy share or carbon intensity thresholds), financial optimization goals (e.g., ROI targets or payback periods), resiliency requirements (e.g., backup power reserves or critical load prioritization), data-sharing and privacy settings, flexibility tolerances (e.g., comfort ranges or workload latency), participation in grid services (e.g., demand response or ancillary markets), lifestyle scheduling preferences (e.g., time-of-use or travel schedules), and redundancy/security levels for energy and compute operations. In some aspects, the user defined parameters can be set directly at the router or may be set using a connected app or interface. It is also noted that any of the user defined parameters described above can also be learned by the router automatically by observing load behavior of the connected assets, as described herein.

The device dynamically shifts or curtails flexible loads while maintaining uninterrupted service to non-flexible loads, controls charging and discharging of storage and EVs, executes real-time energy trades, and simultaneously allocates compute workloads across a federated virtual data center (FVDC) and/or flexible edge compute meshes (FEC) formed by interconnected devices. For example, in some cases, allocating kilowatt-hours to compute can be significantly more lucrative than allocating them back to the energy grid. Thus, by being able to compare the market costs for compute and energy in real-time, the router systems described herein are advantageously capable of creating unparalleled value through dual orchestration of energy and compute resources. The system leverages AI algorithms for controlling energy assets behind the meter that utilize reinforcement learning, as well as supervised, self-supervised, and unsupervised machine learning techniques, to predict energy generation and consumption patterns, learn from user load behavior, analyze weather conditions, evaluate grid conditions, forecast weather and grid events, optimize the operation of energy assets, and provide real-time decision-making capabilities.

Unlike centralized, cloud-based systems, the disclosed device operates natively behind the meter with embedded AI, enabling real-time localized decision-making. Unlike traditional smart panels, the systems described herein integrate compute orchestration as a first-class function and unlike decentralized compute networks such as Decentralized Physical Infrastructure Networks (DePINs), which lack energy flexibility, the disclosed system uniquely combines energy flexibility and workload flexibility into a dispatchable, grid-interactive platform compatible with evolving regulatory frameworks such as demand response programs and balancing market requirements.

The systems and methods described herein are applicable across residential, commercial, and industrial environments. In residential applications, the routers can manage rooftop solar arrays, home batteries, EVs, and household loads (e.g., lights, refrigerators, heating/cooling systems, etc.), reducing costs and enabling participation in demand flexibility programs. In commercial installations, the routers can coordinate multiple DERs and flexible loads such as HVAC and refrigeration systems, lighting, and more, while offering transactive energy participation and workload redistribution. In industrial systems, the routers can integrate large-scale storage, EV fleets, and distributed generation assets, contributing to dispatchable virtual power plants that provide firm capacity, grid services, and resilience during outages.

The system enables households, businesses, and communities to operate as decentralized nodes within dispatchable VPPs, providing demand flexibility and participating in transactive energy markets. Orchestration policies are optimized based on pricing, carbon intensity, and grid conditions, ensuring both electrons and workloads are dispatched according to system objectives. Workload orchestration involves allocating resources across FVDCs and/or FEC meshes, which operate without requiring persistent storage at the node, thereby enabling compliance with data-residency and privacy constraints. This results in enhanced energy efficiency, reduced energy costs, and improved integration of renewable energy sources while providing utilities with reliable, autonomous capacity that is both energy-and compute-aware.

### Energy Orchestration Router

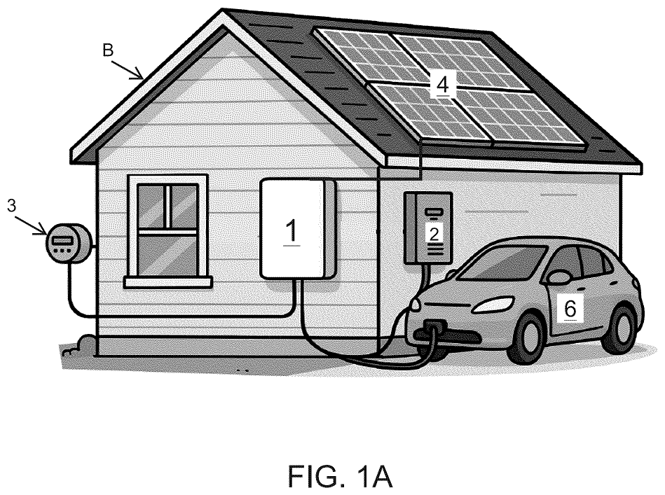

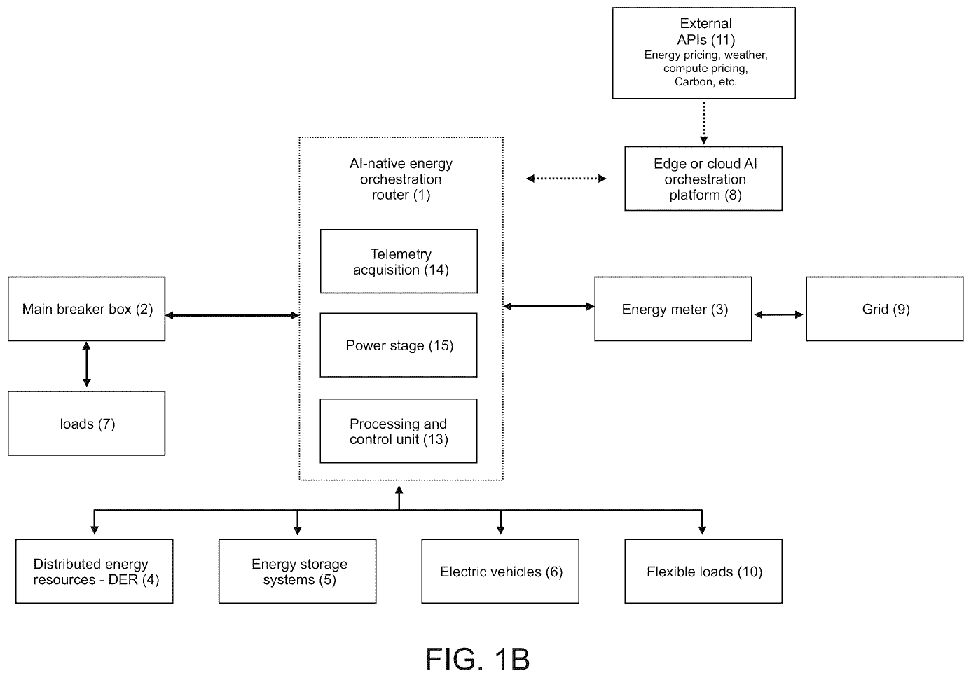

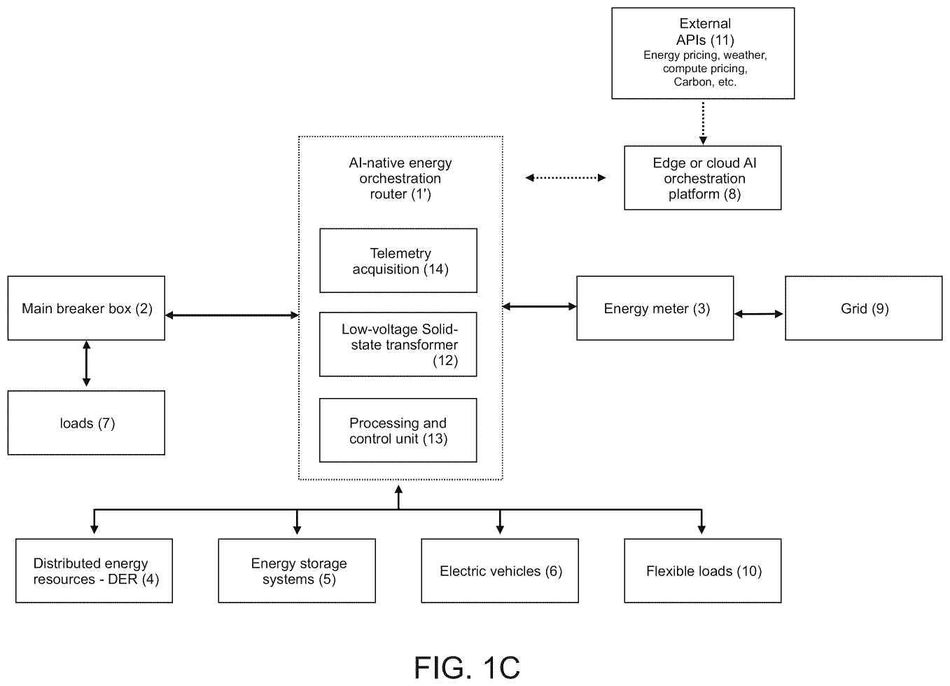

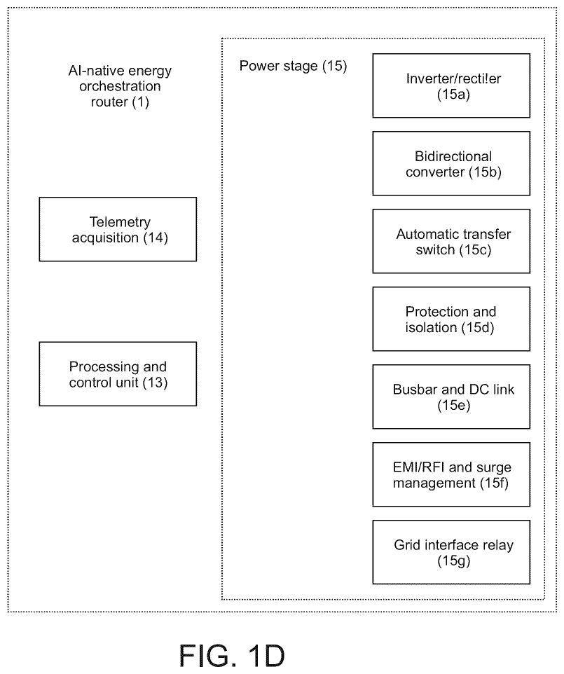

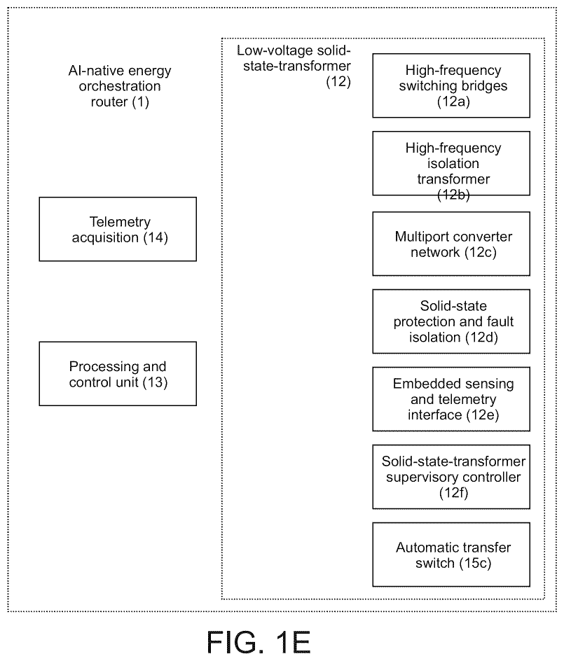

FIG. 1A depicts an exemplary energy ecosystem that is located at the edge of the grid and that includes an energy orchestration router, according to the systems and methods described herein. As shown in FIG. 1A, an energy orchestration router (1) can be installed on a building (B). In some cases, the building (B) can be a residence, commercial building, industrial building, or any other building which would benefit from autonomous edge energy orchestration, as described in greater detail below. As shown in FIG. 1A, the router (1) can be installed between the main breaker box (2) of the building (B) and the energy meter (3) of the building (B). The router can include a communication interface, allowing for the router (1) to communicatively couple to the utility energy meter (3), the main breaker panel (2), and one or more energy assets provided at the building (B). In some aspects, the one or more energy assets provided at the building (B) can include distributed energy resources (DERs) which can include, for example but not limited to, solar panels/arrays, wind turbines, combined heat and power systems, etc. The one or more energy assets can also include energy storage systems (ESSs), which can include, for example but not limited to, batteries (e.g., lithium-ion batteries), flywheels, compressed air energy storage, pumped hydro storage, etc. The one or more energy assets can also include assets which can be classified as both DERs and ESSs, such as electric vehicles (EVs). As shown, the assets of the energy ecosystem of FIG. 1A include a DER (4) which is a solar array, and an EV (6). The one or more energy assets also include one or more loads, which can either be flexible or non-flexible loads on the building (B). For example, loads on the building can include lights in the building, HVAC systems, TVs, refrigerators and other appliances, etc. Details of the one or more energy assets which can be tied into the router (1) are described in greater detail below.

In some aspects, as shown the communication interface of the router (1) can include a plurality of wired connections to physically couple the router (1) to the meter (3), breaker (2) and the energy assets (e.g., the solar array, EV, and loads within the building). In some aspects, the communication interface can also include a telemetric acquisition interface adapted to receive data from any of the one or more energy assets wirelessly. The telemetric interface can also be adapted to receive data wirelessly from one or more additional inputs, via APIs. These additional inputs can include, for example, energy pricing data, compute pricing data, weather data, carbon intensity signals, grid dispatch commands, net metering, feed-in tariffs, demand response programs, grid status, etc.

The router (1) also includes at least one processor (e.g., a GPU) configured to receive all of the data discussed above and use the data to execute AI-based orchestration policies, in real-time, to dynamically optimize operation of the one or more energy assets. The architecture and overall functionality of the router (1) and the AI-based orchestration policies are discussed in greater detail below.

FIGS. 1B-1C illustrate various embodiments of energy orchestration routers, according to the systems and methods described herein, and how they tie into an edge energy ecosystem. FIG. 1B shows an AI-native energy orchestration router (1) strategically positioned between a utility energy meter (3) and a main breaker box (2), where it serves as the central control point for all energy flows within the building, similarly to as described above in reference to FIG. 1A. The router (1) connects to these components via a communication interface that includes both wired and wireless connections, enabling comprehensive monitoring and control of the entire energy ecosystem.

The router (1) comprises a communication interface, which can include a telemetry acquisition module (14). The router (1) also includes a power stage (15) and a processing and control unit (13). Electricity flows from the grid (9) through the energy meter (3) into the router (1), where the power stage (15) conditions and routes energy under intelligent control of the processing and control unit (13). This architecture enables the router to orchestrate the DERs (4), ESS (5), EV (6), flexible loads (10), non-flexible loads (7), and grid interfaces (9) in real time, allowing households, businesses, and communities to operate as nodes within dispatchable VPPs and participate in transactive energy markets.

The router's strategic positioning between the meter (3) and main breaker panel (2) allows it to serve as the primary control and routing point for all downstream assets. Energy entering from the grid interface (9) or generated by DERs (4) flows through the device before reaching the breaker panel (2) and connected loads (10, 7), enabling the router to direct, prioritize, and arbitrate energy flows under AI policy control. Simultaneously, the device integrates processing capabilities that manage workload flexibility, distributing compute tasks across local and distributed processing units to form FVDCs and FEC meshes.

### Communication Interfaces

The system communication interfaces include both hardwired energy pathways that carry electrical power between the meter, panel, DERs, ESS, EVs, and loads, and digital data and control interfaces that exchange telemetry, orchestration policies, market signals, and workload distribution commands between the router (1), external APIs, and other devices. By having both wired and wireless connectivity, the systems and methods described herein are able to simultaneously control physical energy flexibility and digital workload flexibility with precision. The communication interfaces enable bidirectional data exchange with DERs, ESS, EVs, loads (10, 7), grid systems, external APIs, and compute marketplaces. Supported protocols may include Modbus, SCADA, CAN, OCPP, Ethernet, Wi-Fi, GSM, and 5G. External inputs may include energy pricing, weather forecasts, carbon intensity signals, and dispatch requests from grid operators. Outputs may include orchestration policies, telemetry summaries, and transactive energy bids.

The communication interfaces also include the telemetry module (14), which measures electrical parameters of the one or more energy assets, including voltage, current, harmonics, power factor, frequency, and temperature, as well as grid quality indicators. It also monitors compute telemetry, such as processor utilization, workload allocation, and thermal conditions. These measurements provide real-time input to orchestration decisions and can be processed locally or optionally transmitted in summarized form to cloud-based orchestration systems. The telemetry acquisition module (14) continuously monitors operating parameters across all connected assets, including DERs (4), ESS (5), EVs (6), flexible loads (10), non-flexible loads (7), and the power stage (15) itself.

### Processing and Control Unit

The processing and control unit (13) includes, but not limited to, at least one processing unit (PU), which may be implemented as a CPU, GPU, NPU, FPGA, quantum accelerator, or other processing element. The PU executes on-device AI inference, implements orchestration policies, and manages both energy and workload flexibility. Energy flexibility includes routing electrons, prioritizing flexible loads (10), and ensuring uninterrupted service to non-flexible loads (7), while executing switching commands. Workload flexibility is implemented within the same control loop, dynamically allocating compute tasks locally or across distributed meshes while ensuring that energy orchestration objectives are not compromised. Idle or underutilized or underutilized compute cycles may be monetized by integration with external marketplaces.

The processing unit executes orchestration policies generated locally or via an edge or cloud AI orchestration platform (8), while external communication APIs (11) provide additional inputs including energy pricing, compute pricing, weather data, carbon intensity signals, grid dispatch commands, net metering, feed-in tariffs, demand response programs, and grid status information.

### Power Stage

The power stage (15) of FIG. 1B is responsible for multi-port, bidirectional energy conversion and distribution. In one embodiment, the power stage (15) is implemented as a conventional modular power-electronics architecture, including inverter/rectifier modules, bidirectional DC/DC converters, busbar and DC-link networks, EMI/RFI filtering, protection circuits, and an automatic transfer switch (ATS) (15c) configured for regulatory-compliant source switching including, but not limited to with UL 1741-SB, IEEE 1547, and anti-islanding standards.

For example, FIG. 1D illustrates the internal architecture of the power stage (15) of FIG. 1B, which leverages modular power-electronics for bidirectional energy conversion and distribution across multiple AC and DC interfaces. The power stage (15) includes an inverter/rectifier module (15a) for grid-tied AC/DC conversion, one or more bidirectional DC/DC converter stages (15b) for interfacing with energy storage systems (ESS) (5) and electric vehicles (EVs) (6), and an automatic transfer switch (ATS) (15c) that enables regulatory-compliant switching between the grid (9), distributed energy resources (DERs) (4), ESS (5), and backup power sources. Protection and isolation circuits (15d), including breakers, fuses, and contactors, provide fault detection and safety isolation. A busbar and DC-link network (15e), comprising capacitors, pre-charge circuits, and bleed resistors, buffers and stabilizes energy flows for controlled routing. EMI/RFI filters and surge suppression circuits (15f) reduce conducted and radiated noise while protecting against transient surges. A grid interface relay (15g) provides anti-islanding functionality and ensures compliance with regulatory grid-interconnection standards. The telemetry acquisition module (14) monitors voltage, current, harmonics, thermal conditions, and power quality across all submodules of the power stage (15). These measurements are communicated to the processing and control unit (13), which executes AI-driven orchestration policies received from the orchestration platform (8). The processing unit (13) issues control commands to the inverter/rectifier (15a), DC/DC converters (15b), ATS (15c), and other submodules to dynamically balance flows between DERs (4), ESS (5), EVs (6), flexible loads (10), and non-flexible loads (7). Hardwired energy connections link the power stage (15) to physical assets. At the same time, dashed data/control interfaces connect the processing unit (13), orchestration platform (8), and external APIs (11), enabling continuous policy updates, market data integration, and execution feedback. This embodiment demonstrates orchestration of distributed assets using established power-electronics topologies while maintaining compatibility with AI-based optimization frameworks, allowing predictive policies to shift or curtail flexible loads (10) while preserving continuous supply to non-flexible loads (7).

FIG. 1C illustrates an alternative embodiment of the system shown in FIG. 1B that includes an energy orchestration router (1′). The power stage of the energy orchestration router (1′) is a low-voltage solid-state transformer (LV-SST) (12), rather than the power stage (15) of the router (1) of FIG. 1B described above. The router (1′) can include similar components to the router (1) of FIG. 1B, accordingly, like components will not be described. The LV-SST (12) includes high-frequency switching bridges, a high-frequency isolation transformer, a multi-port converter network, embedded sensing circuits, and an SST supervisory controller. Similarly to as described above, the transformer (12) executes switching commands issued by the processing unit (13) to manage load prioritization, charging and discharging cycles, energy export and import, and dispatchable VPP participation.

The LV-SST (12) provides high-frequency switching, galvanic isolation, and multi-port bidirectional conversion, enabling direct orchestration of simultaneous energy flows across AC and DC interfaces. In this configuration, the LV-SST (12) routes power between the grid (9), DERs (4), ESS (5), EVs (6), flexible loads (10), and the main breaker box (2), which powers non-flexible loads (7). The processing and control unit (13) executes AI-driven orchestration policies that determine whether to import, export, store, or redistribute energy, while ensuring that non-flexible loads (7) remain continuously supplied and flexible loads (10) are shifted, curtailed, or rescheduled as needed. The telemetry acquisition module (14) monitors system parameters, including voltage, current, harmonics, port-level switching, and thermal states of the LV-SST (12), feeding real-time data back to the processing unit (13). An automatic transfer switch (ATS) (15c), integrated for regulatory compliance, allows safe and seamless transitions between grid supply, DERs, ESS, and backup power sources. External APIs (11) deliver market pricing, weather forecasts, carbon intensity signals, and grid dispatch requests to the AI orchestration platform (8), which generates policies that the processing unit (13) executes through the LV-SST (12). By replacing discrete inverters and converters with the LV-SST (12), this embodiment enables high-speed, fine-grained orchestration of multi-port energy flows under predictive AI control, delivering improved efficiency, demand flexibility, and dispatchable capacity while preserving uninterrupted service to critical non-flexible loads.

For example, FIG. 1E illustrates the internal architecture of the LV-SST (12) of FIG. 1C, which performs multi-port, high-frequency, bidirectional conversion, enabling simultaneous energy routing across multiple AC and DC interfaces. As shown, the LV-SST (12) comprises high-frequency switching bridges (12a), implemented using wide-bandgap devices such as GaN or SiC, which provide efficient and fast bidirectional power routing. A high-frequency isolation transformer (12b) provides galvanic isolation and voltage adaptation between ports. A multi-port converter network (12c) supports concurrent AC/DC and DC/DC power flows, allowing direct orchestration between distributed energy resources (DERs) (4), energy storage systems (ESS) (5), electric vehicles (EVs) (6), flexible loads (10), and the main breaker box (2), which powers non-flexible loads (7). Solid-state protection and isolation circuits (12d) provide sub-millisecond fault detection and disconnect, ensuring operational safety. Embedded sensing and telemetry interfaces (12e) measure voltage, current, harmonics, power factor, and thermal conditions in real time. These measurements are communicated to the telemetry acquisition module (14) and the processing and control unit (13), which executes AI-driven orchestration policies. A dedicated SST supervisory controller (12f) coordinates switching sequences, protection logic, and orchestration commands under predictive policies generated by the AI orchestration platform (8). An automatic transfer switch (ATS) (15c), as shown in the embodiment of FIG. 1D, ensures regulatory-compliant source switching between the grid (9), DERs (4), ESS (5), and backup generation paths. Solid lines represent hardwired energy connections between the LV-SST (12) and the physical assets, while dashed lines represent data and control links connecting the processing unit (13), telemetry acquisition module (14), and orchestration platform (8). This embodiment enables AI-driven energy orchestration with sub-second responsiveness, precise load prioritization, and compatibility with both flexible loads (10) that may be shifted or curtailed and non-flexible loads (7) that require uninterrupted supply, thereby ensuring both operational resilience and grid-interactive capability.

Through this integrated architecture, the routers (1), (1′) intelligently separate flexible loads (10), which may be shifted, curtailed, or scheduled based on grid conditions and pricing signals, from non-flexible loads (7), which remain continuously powered to ensure uninterrupted service to critical systems. By managing both types of loads alongside DERs, ESS, and EVs under unified AI-driven control, the device enables real-time optimization of behind-the-meter resources, integration with external energy markets, and seamless coordination between energy and compute orchestration functions.

When deployed as a fleet, multiple routers (1), (1′) can communicate securely to form aggregated, dispatchable VPPs. Each router contributes demand flexibility by coordinating charging and discharging of ESS and EVs, dynamically routing DER generation, and managing flexible loads (10) while ensuring continuous support of non-flexible loads (7). The fleet can respond collectively to grid operator signals or transactive market events to provide firm, dispatchable capacity. Simultaneously, the processing units within each router can cooperate to allocate idle or underutilized compute resources into edge compute meshes, enabling distributed execution of workloads across a FVDC or FEC without compromising energy orchestration performance. Examples of idle or underutilized compute resources can include computing systems embedded in electric vehicles, residential consumer electronics, gaming systems, smart appliances, networking equipment, energy devices such as inverters and meters, and industrial IoT systems. These resources may be fully idle or partially unused, with capacity dynamically reallocated to external computing tasks without impairing primary functions, thereby transforming latent processing capability into a monetizable infrastructure resource.

### AI Orchestration Platform

The orchestration framework executes a multi-stage policy engine, including data acquisition, predictive modeling (e.g., via digital twin simulations), decision optimization, and a self-learning engine. The AI platform generates policies for energy flexibility (shifting, curtailing, charging, discharging, exporting) and for workload flexibility (allocating idle compute across nodes). In some aspects, the orchestration policies may also incorporate carbon intensity signals, allowing the orchestration platform to shift flexible loads (10) toward periods of higher renewable penetration while ensuring non-flexible loads (7) remain powered. The orchestration policies can be refined using both local execution feedback and flexible learning across multiple routers, enabling fleet-wide optimization while preserving data privacy. Details of the AI orchestration platform are described in greater detail below.

By integrating power electronics, embedded compute, telemetry acquisition, and AI-driven orchestration within a single hardware platform, the systems and methods described herein establish a new infrastructure layer that simultaneously manages energy flexibility and workload flexibility. This dual capability enables the creation of dispatchable VPPs, delivery of demand flexibility, and seamless participation in transactive energy markets, while also unlocking value from distributed compute resources.

The orchestration routers (1) and (1′), and AI-based methods described herein can be used to perform a wide range of operations. For example, in a standalone orchestration, a single router (1), (1′) can be arranged to manage DERs, ESS, EVs, and loads (10, 7) behind one meter to provide demand flexibility, cost optimization, and prioritization of renewable energy sources. Additionally or alternatively, an aggregated orchestration can allow for a plurality of routers (1), (1′) to interconnect securely to operate as a dispatchable VPP, aligning orchestration policies to deliver firm capacity to utilities or market operators. In another aspect, in a transactive energy participation configuration, routers (1), (1′) can autonomously negotiate pricing, execute trades, and exchange energy with peers or market systems. Additionally, in a workload orchestration, the processing units within the routers (1), (1′) can form an FVDC or FEC mesh, which can allow for compute workloads to be allocated across nodes without compromising local energy flexibility.

### AI-native Orchestration Model

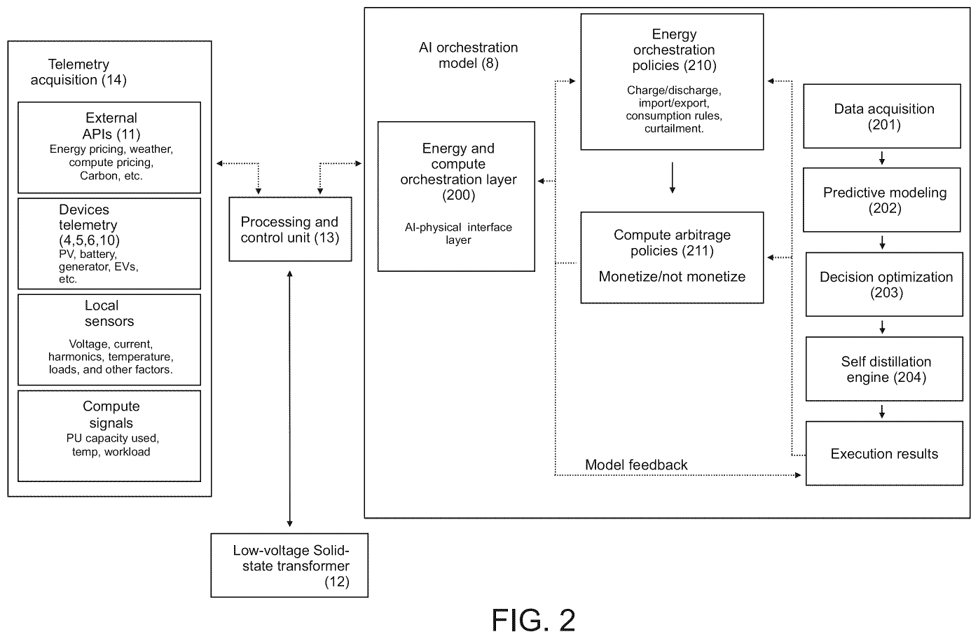

FIG. 2 illustrates one exemplary architecture of an AI-native orchestration model (8) implemented by the energy orchestration router (1) or (1′), which can execute predictive and real-time orchestration policies locally through the processing and control unit (13) and remotely through the AI orchestration platform (8). The telemetry acquisition module (14) aggregates multiple data streams, including: (i) inputs from external APIs (11) that provide energy pricing, compute pricing, weather forecasts, carbon intensity levels, etc. ; (ii) real-time telemetry from connected assets (e.g., telemetric outputs from connected assets/asset sensors; and (iii) internal sensing circuits measuring voltage, current, harmonics, thermal states, power quality, and processing unit (13) utilization and workload allocation. The AI orchestration platform (8) can include modular inference stages: a data acquisition stage (201); a predictive modeling engine (202), which may employ digital twin simulations; a decision optimization engine (203) that can evaluate orchestration strategies; and a self-distillation learning engine (204) that can refine policies based on feedback. Feedback can include telemetry from the execution layer (200), energy orchestration outcomes (210), and compute arbitrage outcomes (211). The resulting energy orchestration policies (210) may govern charging and discharging cycles, grid import and export behavior, renewable prioritization, and load management, including the curtailment or shifting of flexible loads (10) while ensuring continuous supply to non-flexible loads (7). The compute arbitrage policies (211) can determine whether idle processing resources of the PU (13) are monetized through external compute marketplaces or retained for local inference tasks. Data and control lines can provide bidirectional exchange between the orchestration platform (8), the processing and control unit (13), the telemetry module (14), and external APIs (11), ensuring continuous policy delivery, telemetry feedback, and model refinement. Hardwired energy connections link the power stage (15) or the low-voltage solid-state transformer (12) to DERs (4), ESS (5), EVs (6), flexible loads (10), non-flexible loads (7), and the grid (9), to allow for the orchestration policies to be physically executed. This architecture clearly separates digital policy signaling from physical energy switching, enabling the device to operate as a unified orchestration framework capable of optimizing energy flows, executing demand flexibility, aggregating into dispatchable virtual power plants, participating in transactive energy markets, monetizing compute capacity, and delivering grid-interactive services in real time.

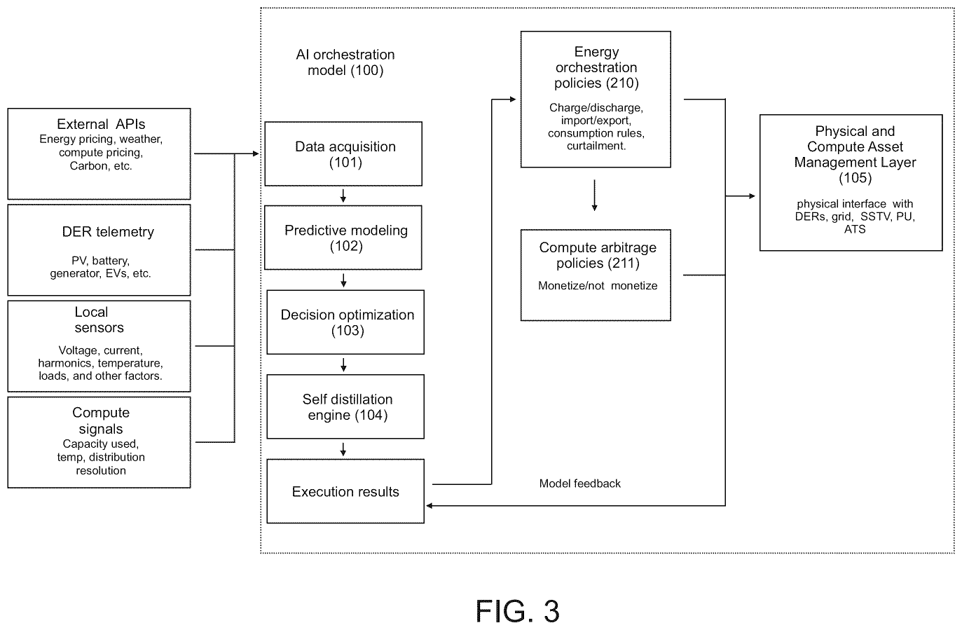

FIG. 3 is an alternative illustration of a similar AI-native orchestration model (100) for distributed energy and compute resources. The model (100) is described below in reference to FIGS. 3-7 is described agnostic of the routers described above, as the orchestration models described herein could be modified to operate on routers distinct from the routers described herein. The model (100) can include a multi-source data acquisition module (101) collects heterogeneous real-time data from external APIs, one or more energy assets (e.g., DERs), local high-resolution sensors, and compute marketplaces. The predictive modeling engine (102) generates forecasts for energy pricing, renewable generation potential, carbon intensity, and compute workload profitability. The decision optimization engine (103) produces software-defined orchestration policies (210 for energy, 211 for compute), which are transmitted to the Physical & Compute Asset Management Layer (105) for execution. This layer interfaces directly with the one or more energy assets (e.g., DERs), grid import/export nodes, Slow Scan Television (SSTV)-based switching, ATS controllers, and distributed compute resources. Real-time telemetry from actuated assets is fed back into the AI model, and the self-distillation learning engine (104) refines predictive models and orchestration strategies while sharing distilled orchestration policies across nodes, enabling closed-loop autonomous optimization.

The multi-source data acquisition module (101) can serve as the foundation layer, collecting heterogeneous real-time data from external APIs (energy pricing, weather, carbon intensity, compute pricing), DER telemetry (PV inverters, batteries, EV chargers, generators), local high-resolution sensors (voltage, current, harmonics, thermal data, loads), and distributed compute marketplaces (GPU pricing, workload availability). The predictive modeling engine (102) can process this collected data to generate short-and long-term forecasts for energy pricing, renewable generation potential, carbon intensity levels, and compute workload profitability. The decision optimization engine (103) can produce software-defined orchestration policies (210 for energy and 211 for compute), balancing consumption, storage, export, curtailment, and compute allocation decisions. These policies are transmitted to the Physical & Compute Asset Management Layer (105) for execution, enabling direct control of one or more energy assets, grid import/export interfaces, SSTV-based switching, ATS controllers, and distributed compute workloads. The self-distillation learning engine (104) can continuously evaluate executed orchestration outcomes against predicted results to refine the predictive models and improve the decision optimization parameters over time. The model (100) can also be arranged to share distilled orchestration policies across distributed nodes, enabling federated learning without transmitting raw telemetry, this preserving user privacy. The execution layer (105) provides a unified control interface between the orchestration model and heterogeneous hardware and compute endpoints to handle low-level communication and actuation with energy assets, grid interfaces, SSTV, ATS, and compute marketplaces while feeding real-time telemetry back to the model (100) for continuous improvement, completing the closed-loop autonomous control cycle.

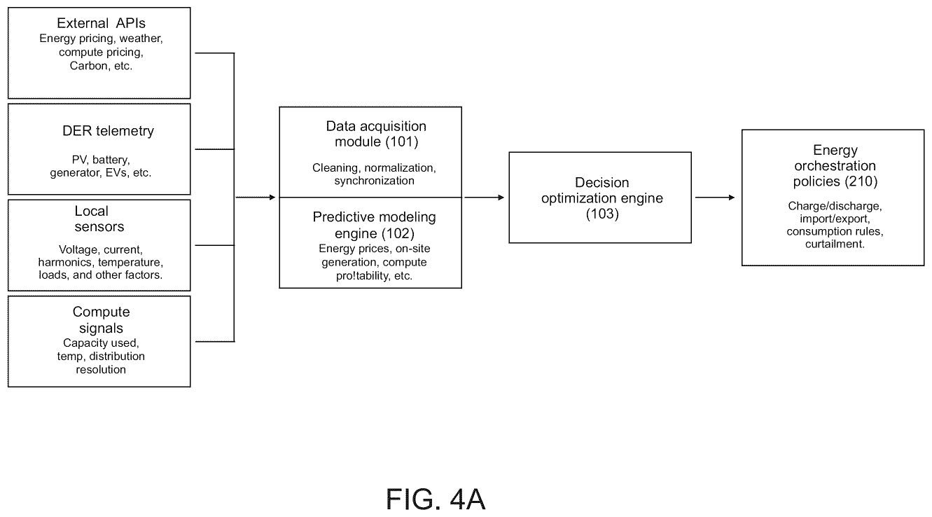

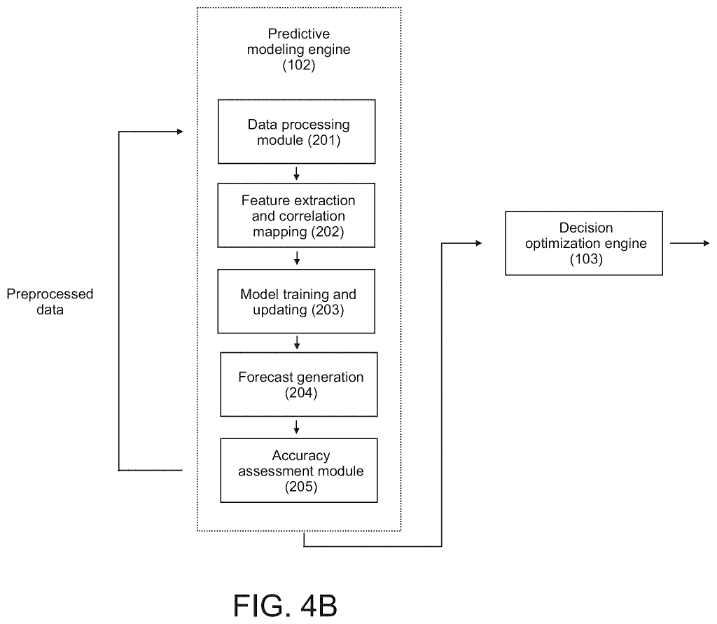

FIG. 4A depicts the data acquisition and forecasting pipeline used by the AI orchestration model (100). The multi-source data acquisition module (101) integrates external APIs (energy prices, carbon intensity, weather, compute marketplace signals), DER telemetry (PV inverters, batteries, EV chargers, generators), local high-resolution sensors, and distributed compute marketplaces. The collected data is processed by the predictive modeling engine (102) to generate forecasts for energy pricing, renewable generation, carbon intensity, and compute workload profitability. These forecasts are provided to the decision optimization engine (103) for policy generation and subsequent execution via the Physical & Compute Asset Management Layer (105).

FIG. 4B illustrates an exemplary internal workflow of the predictive modeling engine (102) described above in reference to FIGS. 3 and 4A. As shown, the engine (102) can include a data preprocessing layer (201) to clean, normalize, and synchronize inputs, followed by a feature extraction and correlation mapping layer (202) which identifies relevant energy, environmental, and computational variables. A model training and updating layer (203) can also be provided to apply machine learning techniques, enabling the training of predictive models using both historical and real-time data, as discussed in the examples provided below.

A forecast generation layer (204) can produce predictions for energy pricing, renewable generation, carbon intensity, and optionally compute workload profitability. Additionally, an accuracy assessment module (205) can validate forecast quality, assign confidence scores, and continuously adjust model weights to improve predictive performance.

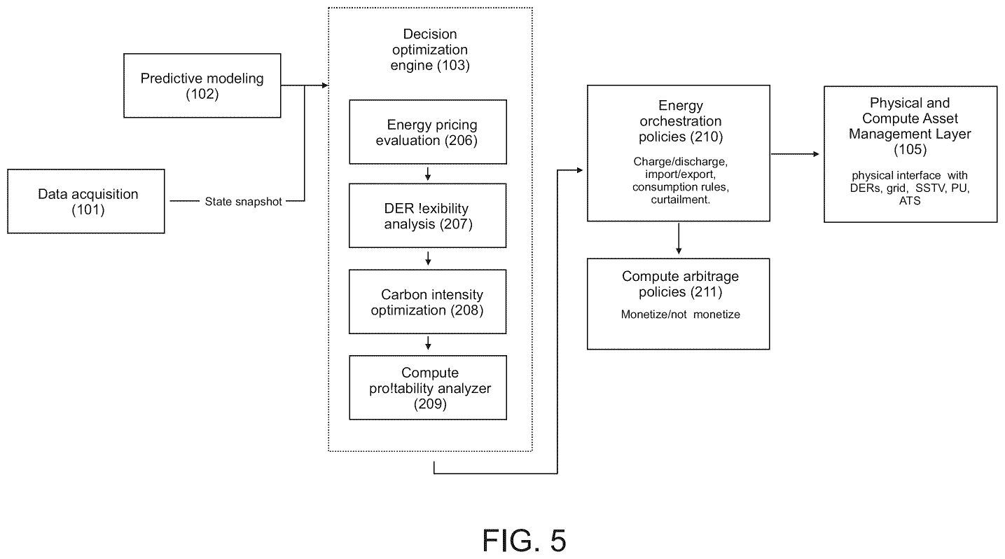

FIG. 5 illustrates the decision optimization engine (103) of the orchestration model (100) described above in reference to FIGS. 3-4B. As shown, the engine (103) can generate software-defined orchestration policies based on forecasts from the predictive modeling engine (102) and real-time inputs from the multi-source data acquisition module (101). As shown in FIG. 5, the engine can produce energy orchestration policies (210) which, when executed by an orchestration router (e.g., router (1) of FIG. 1A), can allocate energy flows across consumption, storage, export, and curtailment, and compute arbitrage policies (211) which, when executed by a router, can allocate or suspend compute workloads based on profitability thresholds and energy availability. These orchestration policies (210 and 211) may be automatically transmitted to the Physical & Compute Asset Management Layer (105), which can execute control commands on the energy assets (e.g., photovoltaic inverters, batteries, EV chargers, generators, distributed compute resources, etc.), SSTVs, ATS controllers, and grid import/export nodes, while real-time execution feedback from 105 is sent back to both the data acquisition module (101) and the self-distillation framework (104), enabling a continuous closed-loop optimization of predictive models and decision parameters.

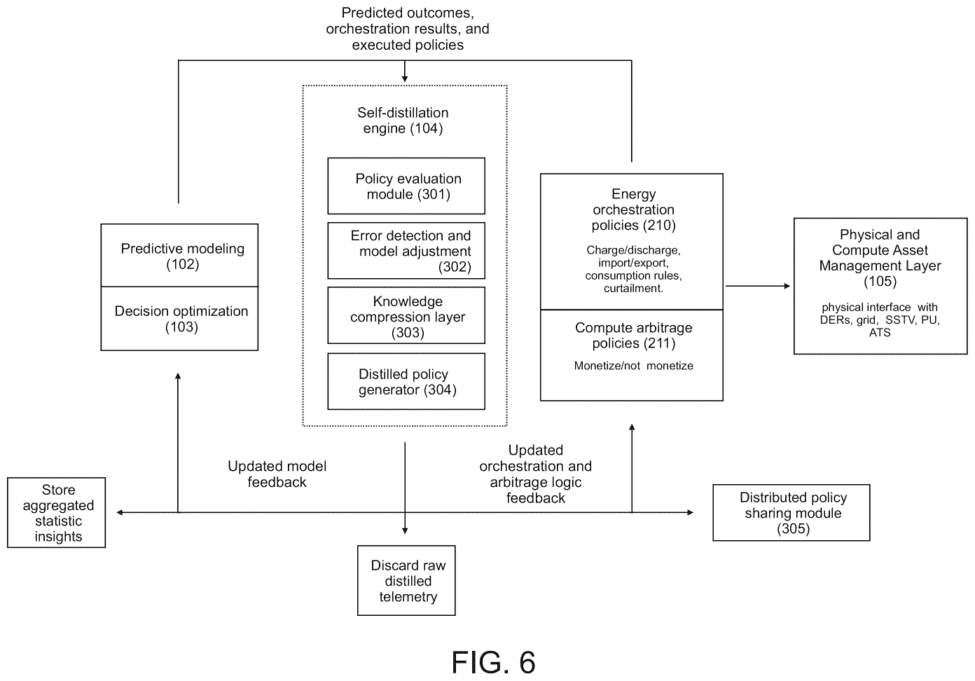

FIG. 6 illustrates the self-distillation learning framework (104) of the orchestration model (100) described above in reference to FIG. 3, which is configured to continuously refine orchestration strategies based on the executed outcomes of orchestration policies. The framework can evaluate the performance of executed policies by comparing actual results received from the Physical & Compute Asset Management Layer (105) against forecasts generated by the predictive modeling engine (102) and policies defined by the decision optimization engine (103). Based on these comparisons, the framework can refine predictive models (102) and optimization parameters (103), compress knowledge representations by discarding unused raw telemetry while retaining aggregated statistical insights, generate distilled orchestration policies for improved decision-making, and share the distilled policies with other nodes via the distributed policy sharing network (305), thereby enabling privacy-preserving federated learning and collective optimization while maintaining autonomous closed-loop control at each local node.

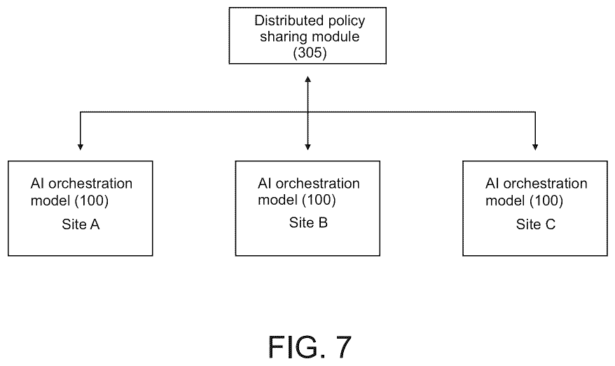

FIG. 7 illustrates an exemplary distributed policy sharing and federated learning architecture which can be implemented across a network of multiple energy orchestrations systems described herein. As shown, each site can operate an independent instance of an orchestration model (100), which can include all of the components and functionalities described above. Each model 100 can execute orchestration policies locally to control the various connected energy assets, grid interfaces, SSTVs, and ATS controllers, as described above. The self-distillation learning engine (e.g., engine (104)) within each node can generate distilled orchestration policies based on local execution outcomes, which can then be exchanged between nodes via a distributed policy sharing network (305). It should be noted that the systems described herein can be designed such that raw telemetry data is never shared, ensuring privacy-preserving federated learning while enabling collective optimization across a network of distributed orchestration agents.

### Deployment Examples

### Example 1: Residential Deployment

In a residential deployment, a router (e.g., router (1) of FIG. 1A) running an orchestration model (100), can be installed between the utility meter and the main breaker panel of the residence. The router can also be connected to, and arranged to manage, a variety of energy assets, which can include but are not limited to solar panels/arrays, home batteries, EV batteries/chargers/computers, and household loads (e.g., HVAC systems, refrigeration systems, washer/driers and lighting systems, TV, etc.). During daily operation, the multi-source data acquisition module (101) can ingest weather forecasts, grid pricing signals, carbon indicators, and local DER telemetry to monitor the stability of the grid, the cost of electricity, and the consumption patterns of household loads. The predictive modeling engine (102) can forecast consumption, generation, pricing, and carbon profiles, while the decision optimization engine (103) generates energy orchestration policies (210) to balance storage, consumption, and exports, and compute arbitrage policies (211) to dispatch idle or underutilized GPU capacity to compute marketplaces, when profitable.

Using the telemetry module, the router can identify non-critical loads and apply orchestration policies to shift or curtail their operation during high-cost periods, while ensuring critical loads remain powered. Simultaneously, the router can manage the charging and discharging of stationary batteries and an electric vehicle, scheduling charging during periods of low cost or low carbon emissions and discharging to cover peak household demand. The power stage, implemented with an LV-SST, for example, can route energy in real time across AC and DC ports under AI control. In parallel, the processing unit allocates unused GPU cycles into a flexible virtual data center (FVDC) and flexible edge compute (FEC) mesh, providing workload flexibility while maintaining energy orchestration as the primary function. This configuration enables demand flexibility behind the meter, reducing costs, optimizing the integration of renewable energy sources, maintaining grid support without requiring manual intervention, monetizing idle compute resources and optimizing for carbon intensity. For example, during high-demand pricing spikes, the model automatically discharges the battery, pauses EV charging, sells excess solar power, and monetizes idle compute cycles simultaneously. The Physical & Compute Asset Management Layer (105) executes these policies, while the self-distillation framework (104) refines future strategies and optionally shares distilled policies via the distributed policy sharing network (305), enabling collaborative optimization without sharing raw telemetry.

Additionally, during daily operation, the model can also learn from load behavior at the residence. For example, the model can learn that there is a higher load in the kitchen of the residence in the evenings of the owner is routinely home in the evenings, cooking meals in the oven, with the lights. In another example, based on varying and static loads on the residence during the day, the model may learn that the resident is out of the residence from 9 am-5 pm during the work week. All of this information can be input into the orchestration algorithm to improve the energy orchestration to best meet the resident's needs.

### Example 2: Commercial Deployment

In a commercial deployment, router(s) running the orchestration model (100) can be installed between the utility meter(s) and main breaker panel(s) of multiple facilities. In this case, the model (100) can coordinate, for example rooftop solar, stationary batteries, HVAC systems, and compute resources across the multiple facilities to minimize costs, optimize carbon usage, and maximize distributed compute monetization. The multi-source data acquisition module (101) aggregates weather forecasts, grid event notifications, carbon signals, energy pricing data, and compute marketplace pricing. The predictive modeling engine (102) can forecast consumption, DER generation, compute profitability, and emissions profiles, while the decision optimization engine (103) generates energy orchestration policies (210) to dynamically shift loads, manage storage, and export energy, and compute arbitrage policies (211) to allocate workloads based on profitability and carbon intensity. In some aspects, for example, similarly to as described above, the predictive modeling engine (102) can forecast based on information learned from load behavior across the multiple facilities during daily operation to improve the energy orchestration.

During a grid demand-response event, for example, the router can be self-configured to reduce HVAC consumption or reorganize processes, route deferred compute workloads to another facility powered by surplus solar, and/or export energy at peak market prices to increase monetization. Similarly to as described above, policies can be executed via (105). At the same time, (104) refines predictive models and shares distilled policies across facilities via (305), enabling federated learning that improves energy orchestration, carbon-aware decisions, and compute monetization without exposing sensitive data.

### Example 3: Community Microgrid

In a community microgrid implementation, multiple facilities (e.g., households and/or small businesses) may each be provided with a router system(s) operating orchestration models (100) managing DERs, flexible loads, and idle or underutilized compute nodes. In this case, the multi-source data acquisition modules (101) of each router can be configured to collect data, similarly to as described above and each model's predictive modeling engine (102) can forecast consumption, renewable availability, and compute profitability. Each decision optimization engine (103) can then produce energy orchestration policies (210) to optimize storage and sharing among the multiple facilities/participants, as well as compute arbitrage policies (211) to collectively monetize idle or underutilized compute capacity. For example, during a regional energy price surge with low renewable availability, each of the routers at the multiple facilities can configure themselves to orchestrate energy to reduce non-critical loads, such as HVAC systems and EVs, share stored energy across the multiple facilities, and aggregate unused compute cycles for profitable dispatch to compute marketplaces. Similarly to as described above, executed policies can be managed locally via (105), while (104) refines orchestration strategies and shares distilled policies through (305), enabling privacy-preserving federated learning that improves grid stability, carbon-aware optimization, and distributed compute monetization across the microgrid.

### Example 4: Transactive Energy and Peer-to-Peer Trading

Similar to the microgrid example provided above, in a suburban neighborhood implementation, multiple households in the neighborhood can be provided with a router system described herein. In this case, for example, on a hot summer day, electricity demand may increase significantly, leading to a rise in real-time prices reaching utility export limits. When this happens, if one household is unoccupied but has a solar array, an energy storage system, a gas generator, or an EV available, then the router of that household can be configured to detect surplus generation and unused capacity and can initiate a transactive energy event by communicating with the routers of nearby households and the utility. The orchestration framework can then generate an autonomous market bid, offering available capacity at a competitive price. The router can then reduce unnecessary loads, export solar energy through the power stage, and discharge the EV battery in accordance with policy constraints that preserve sufficient charge for mobility needs. Peer routers in the neighborhood accept the trade, and the selling router can execute the transaction securely through its communication interfaces. In parallel, idle or underutilized compute resources can be reallocated to nearby devices in the FVDC or FEC mesh, ensuring that both energy and workload flexibility are leveraged and executed securely through its communication interfaces, in accordance with interconnection constraints. The result is a localized, transactive market that lowers costs, increases household revenue, and improves grid stability.

### Example 5: Fleet Resilience and Dispatchable Virtual Power Plant

The router systems described herein can also be leveraged to maximize a facility's or a fleet of facilities'dispatchable capacity to maintain resilience and support rapid grid restoration during weather anomalies like storms. For example, in a case where a fleet of facilities in Texas are provided with the router systems described herein and there is an incoming winter storm, the routers can be configured detect the storm by receiving local weather data via the connected APIs and/or using local telemetry. Anticipating grid instability, the router fleet can coordinate charging of EVs and stationary batteries during off-peak hours, and align orchestration policies across the fleet (which can be thousands of units). As the storm hits, grid may outages occur in which case individual routers can be configured to prioritize critical loads at their facility such as heating, water pumps, and refrigeration, while shedding non-essential demand. Using the power stage/transformer, the routers can dynamically reconfigure energy flows between energy assets (e.g., DERs, ESS, and loads), to ensure seamless failover and regulatory-compliant transitions with the ATS. At the same time, the routers can operate in aggregated mode as a dispatchable VPP, responding to utility signals and supplying firm capacity from distributed assets. Idle or underutilized compute resources are redistributed across the FVDC or FEC mesh, ensuring workload continuity even in areas with partial outages. Through this combined orchestration of energy and workloads, the fleet demonstrates dispatchable capacity, maintains resilience during the storm, and supports rapid grid restoration.

Further non-limiting aspects or embodiments are set forth in the following examples:

In one example, an AI-native energy orchestration router is configured for installation between a utility energy meter and a main breaker panel, comprising at least one processing unit (PU), a telemetry acquisition module, a power stage, an automatic transfer switch, and communication interfaces, wherein the device is configured to orchestrate distributed energy resources (DERs), energy storage systems (ESS), electric vehicles (EVs), and loads in real time, and wherein the PU executes orchestration policies that simultaneously manage energy flexibility and workload flexibility.

In this example, the loads comprise flexible loads that may be shifted or curtailed and non-flexible loads that remain continuously supplied.

In a further example, the PU executes AI inference to implement orchestration policies, managing energy flexibility by dynamically routing electrons and managing workload flexibility by allocating compute tasks locally or across distributed compute meshes.

In yet another example, the power stage is implemented as a conventional modular power-electronics architecture comprising at least one inverter/rectifier module, bidirectional DC/DC converters, a busbar and DC-link network, EMI/RFI filtering, protection circuits, and an automatic transfer switch configured for regulatory-compliant source switching.

In an alternative example, the power stage is implemented as a low-voltage solid-state transformer (LV-SST) comprising high-frequency switching bridges, a high-frequency isolation transformer, a multi-port converter network, embedded sensing circuits, and an SST supervisory controller.

In one example, the communication interfaces include wired and wireless protocols for secure bidirectional data exchange with DERs, ESS, EVs, loads, grid systems, external APIs, and compute marketplaces.

In another example, the orchestration framework dynamically shifts or curtails loads, manages charging and discharging cycles of ESS and EVs, and prioritizes renewable generation sources to provide demand flexibility while maintaining user-defined preferences.

In a further example, multiple devices interconnect securely to aggregate flexibility and operate as a coordinated fleet providing dispatchable capacity to utilities or market operators, thereby forming a dispatchable virtual power plant (VPP).

In yet another example, the orchestration framework autonomously negotiates energy pricing, generates trade bids, executes peer-to-peer energy exchanges, and interfaces with market operators to enable participation in transactive energy markets.

In one example, the PU dynamically allocates idle or underutilized compute cycles to distributed compute meshes while ensuring priority for energy orchestration, thereby creating workload flexibility and enabling the monetization of unused processing resources.

In another example, orchestration policies are generated using digital twin simulations, predictive analytics, and real-time telemetry, and are refined by a self-learning mechanism that improves orchestration accuracy over time.

In a further example, the orchestration framework supports flexible learning across a plurality of devices, aggregating policies and performance insights without transmitting raw telemetry data, and distributing refined models across the fleet.

In yet another example, orchestration policies jointly and inseparably optimize energy flexibility and workload flexibility according to real-time inputs including energy pricing, compute pricing, grid stability, carbon intensity, and user-defined objectives.

In one example, the device operates in standalone mode to optimize behind-the-meter energy flows, or in aggregated mode to coordinate with other devices as a dispatchable VPP providing grid services including frequency regulation, voltage stabilization, and reactive power balancing.

In another example, the orchestration framework prioritizes non-flexible loads and provides backup power support using ESS or EVs during grid outages, while shedding flexible loads to extend available capacity.

In a further example, idle or underutilized compute workloads are redistributed across a fleet of devices forming a flexible virtual data center (FVDC) and/or flexible edge compute mesh (FEC), such that this redistribution is performed without compromising demand flexibility or dispatchable orchestration.

In yet another example, the orchestration framework integrates carbon intensity data and prioritizes energy flows to reduce emissions.

In one example, the device incorporates a cybersecurity module configured to encrypt data transmissions, protect orchestration policies, and prevent unauthorized access to energy and compute orchestration functions.

In another example, the apparatus comprises a modular and scalable hardware architecture adaptable to residential, commercial, and industrial installations without requiring significant hardware modification.

In a further example, the device enables simultaneous participation in demand flexibility programs, dispatchable VPP services, and transactive energy markets while maintaining local optimization of behind-the-meter resources.

In yet another example, an artificial intelligence orchestration model (100) for real-time autonomous coordination of distributed resources comprises a multi-source data acquisition module (101) configured to collect heterogeneous real-time data from external application programming interfaces (APIs), distributed energy resources (DERs), local high-resolution sensors, grid event notifications, carbon intensity indicators, and distributed compute marketplaces. The model further comprises a predictive modeling engine (102) configured to forecast at least one of: energy consumption, renewable generation potential, energy pricing, carbon intensity levels, and compute workload profitability. The model further comprises a decision optimization engine (103) configured to generate software-defined orchestration policies, including energy orchestration policies (210) for allocating energy among consumption, storage, export, and load curtailment, and compute arbitrage policies (211) for selectively allocating idle or underutilized compute resources to distributed workloads based on profitability thresholds and energy availability. The model further includes a physical & compute asset management layer (105) configured to automatically execute orchestration policies across DERs, grid import/export interfaces, energy storage systems, flexible loads, automatic transfer switches (ATS), solid-state transformers (SSTVs), and distributed compute nodes. The model further comprises a self-distillation learning framework (104) configured to evaluate executed orchestration policies, refine predictive models and decision optimization parameters, and generate distilled orchestration policies for continuous closed-loop improvement, wherein the orchestration model (100) autonomously optimizes energy flows and compute workload allocation across a distributed network. In this example, the self-distillation learning framework is further configured to share distilled orchestration policies with other nodes via a distributed policy sharing network (305) to enable collective optimization without transmitting raw telemetry data.

In this example, the multi-source data acquisition module continuously ingests data from energy pricing APIs, demand forecasts, weather and irradiance sources, carbon intensity signals, telemetry from DERs including photovoltaic arrays, energy storage devices, generators, and electric vehicles, distributed compute marketplaces, and local high-resolution environmental and electrical sensors.

In this example, the predictive modeling engine applies machine learning models to forecast one or more of: marginal and time-varying energy prices, renewable generation output based on environmental conditions, carbon intensity profiles for energy imports and exports, and expected compute workload profitability based on distributed market signals.

In this example, the decision optimization engine (103) generates software-defined orchestration policies configured to balance energy flows between consumption, storage, export, and load curtailment, evaluate compute workload profitability thresholds against energy costs and system availability, and selectively allocate idle or underutilized GPUs, CPUs, NPUs or broaders accelerators or edge computing resources to distributed workloads only when profitability conditions are satisfied.

In this example, the decision optimization engine automatically transmits the generated orchestration policies as executable control commands to a Physical & Compute Asset Management Layer (105) for execution to one or more physical energy assets, including photovoltaic inverters, batteries, EV chargers, generators, and grid import/export interfaces, and optionally dispatches compute workloads to distributed compute nodes or external compute marketplaces for execution without human intervention.

In this example, the self-distillation framework (104) evaluates orchestration policy performance by comparing executed outcomes from physical energy assets and compute workloads against predicted results from the predictive modeling engine (102), discards unused raw telemetry data from controlled energy assets and compute nodes while retaining aggregated statistical insights, and refines predictive models (102) and decision optimization parameters (103) based on feedback from actuated assets and dispatched compute workloads.

In this example, the self-distillation framework generates distilled orchestration policies and shares them with other nodes via a distributed policy sharing network (305) to enable collective optimization across multiple orchestration models without transmitting raw telemetry data.

In this example, the orchestration algorithm is deployable across a fully edge-based configuration executing locally on a device, a cloud-based environment coordinating multi-node orchestration centrally, or a hybrid architecture combining local inference and cloud-level policy sharing.

In this example, the artificial intelligence model executes entirely at the edge on a local device comprising embedded compute resources, providing real-time orchestration without requiring continuous cloud connectivity.

In this example, the artificial intelligence model executes entirely within a cloud environment, aggregating multi-device telemetry and orchestrating resources across geographically distributed nodes.

In this example, the data acquisition module performs preprocessing of incoming data, including cleaning, normalization, feature engineering, and correlation mapping, to enhance model accuracy.

In this example, the decision optimization engine integrates real-time control modules configured to execute orchestration policies with sub-second response times, dynamically update control decisions based on feedback from execution results, and continuously improve operational accuracy through autonomous learning.

In this example, the model further comprises a user-facing interface configured to present recommended orchestration actions and policy outcomes, enable authorized overrides of AI-generated decisions, and display energy and compute performance analytics, cost savings, and carbon reduction insights.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present systems and methods described herein are defined solely by the claims. The features illustrated or described in connection with one exemplary embodiment may be combined with the features of other embodiments. Such modifications and variations are intended to be included within the scope of the present disclosure. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the systems and methods described herein based on the above-described embodiments. Accordingly, the present application is not to be limited by what has been particularly shown and described, except as indicated by the appended claims. All publications and references cited herein are expressly incorporated by reference in their entirety.

1. An energy orchestration router configured to be installed between a utility energy meter and a main breaker panel of a building, wherein the router comprises:
a communication interface configured to communicatively couple the router to the utility energy meter, the main breaker panel, and one or more energy assets provided at the building;
a power stage configured to orchestrate bidirectional energy conversion and distribution for the one or more energy assets; and
at least one processor configured to perform operations comprising
receiving data from the utility energy meter, the main breaker panel, and the one or more energy assets,
generating orchestration policies for allocating energy flows between the one or more energy assets, and
executing the orchestration policies, in real-time, causing the power stage to variously control the flow of electrons between the utility energy meter and the one or more energy assets to dynamically optimize operation of the one or more energy assets based on the orchestration policies.

2. The router of claim 1, wherein the one or more energy assets include any of distributed energy resources (DERs), energy storage systems (ESSs), electric vehicles (EVs), flexible and non-flexible loads on the building, and one or more compute resources.

3. The router of claim 2, wherein the orchestration policies leverage artificial intelligence (AI) models to determine load behavior of the one or more energy assets over time to aid in dynamically optimizing operation of the one or more energy assets.

4. The router of claim 2, wherein the orchestration policies, when executed by the at least one processor, cause the router to allocate computing power from the one or more compute resources into edge compute meshes, while ensuring priority for energy orchestration, thereby creating workload flexibility and enabling monetization of unused processing resources.

5. The router of claim 1, wherein the power stage comprises at least one inverter/rectifier module and bidirectional DC/DC converters configured to execute multi-port, bidirectional energy conversion and distribution in accordance with the orchestration policies.

6. The router of claim 1, wherein the power stage is a low-voltage solid-state transformer (LV-SST) configured to execute multi-port, bidirectional energy conversion and distribution in accordance with the orchestration policies.

7. The router of claim 1, wherein the communication interface includes wired and wireless protocols for secure bidirectional data exchange with the one or more energy assets, grid systems, and external APIs.

8. The router of claim 7, wherein the external APIs are configured to provide the processor with at least one of energy pricing data, compute pricing data, weather forecast data, and carbon intensity level data.

9. The router of claim 2, wherein the dynamic optimization includes any one of shifting or curtailing the flexible loads, managing charging and discharging cycles of the ESSs and EVs, and prioritizing any generation sources to provide demand flexibility.

10. The router of claim 9, wherein the router is configured to interconnect securely with multiple other routers to aggregate flexibility and operate as a coordinated fleet providing dispatchable capacity to utilities or market operators, thereby forming a dispatchable virtual power plant (VPP).

11. A computer-implemented method for autonomous orchestration of distributed energy and compute resources, the method comprising:
collecting, via an energy orchestration router installed between a utility energy meter and a main breaker panel of a building, data from the utility energy meter, the main breaker panel, and one or more energy assets communicatively coupled to the router;
generating, by an artificial intelligence (AI) orchestration model, orchestration policies for allocating energy flows between the one or more energy assets; and
executing the orchestration policies, in real-time, causing the a power stage of the router to variously control the flow of electrons between the utility energy meter and the one or more energy assets to dynamically optimize operation of the one or more energy assets based on the orchestration policies.

12. The method of claim 11, wherein the one or more energy assets include any of distributed energy resources (DERs), energy storage systems (ESSs), electric vehicles (EVs), flexible and non-flexible loads on the building, and one or more compute resources.

13. The method of claim 12, wherein the data received from the one or more energy assets includes behavior data characterizing how the one or more energy assets are used over time, wherein the method further comprises:
training the AI orchestration model using the behavior data to optimize the orchestration policies.

14. The method of claim 12, wherein the executing of the orchestration policies further causes the power stage of the router to allocate computing power from the one or more compute resources into edge compute meshes based on profitability thresholds and energy availability, wherein the one or more compute resources are idle or underutilized.

15. The method of claim 14, wherein the collecting further comprises collecting, via the energy orchestration router, at least one of energy pricing data, compute pricing data, weather forecast data, carbon intensity level data, local router sensor data, and energy asset data from external APIs communicatively coupled to the router, and wherein the generated orchestration policies further comprise predictive forecasts for at least one of energy consumption, renewable generation potential, energy pricing, and compute workload profitability based on the collected data.

16. The method of claim 15, wherein executing the orchestration policies causes the router to control shifting or curtailing of the flexible loads, charging and discharging cycles of the ESSs and EVs, and prioritizing renewable generation sources to provide demand flexibility.

17. The method of claim 11, further comprising:
sharing, via a distributed policy sharing network communicatively coupled to the router, the orchestration policies with a plurality of other energy orchestration routers installed at a plurality of other buildings;
generating, by the distributed policy sharing network, a federated learning dataset; and
training the AI orchestration model using the federated learning dataset.

18. The method of claim 17, wherein executing the orchestration policies causes the router to autonomously negotiate, with the plurality of other energy orchestration routers installed at the plurality of other buildings, regarding energy pricing and generating trade bids, and the method further comprises:
executing, peer-to-peer energy exchanges with one or more of the plurality of other energy orchestration routers, causing the power stage of the router to variously control the flow of electrons between the utility energy meter and the one or more other energy orchestration routers.

19. The method of claim 11, wherein executing the orchestration policies causes the router to provide dispatchable energy capacity to utilities or market operators, thereby forming a dispatchable virtual power plant (VPP).
